(19) United States
(12) Patent Application Publication
(10) Pub. No.: US 2015/0309675 A1
(43) Pub. Date: Oct. 29, 2015

(54) TIMESPIRAL CALENDAR

(71) Applicant: Eduard Blinov, San Ramon, CA (US)

(72) Inventors: Eduard Blinov, San Ramon, CA (US); Igor Cheremukhin, Arkhangelsk (RU); Anton Cheremukhin, Arkhangelsk (RU); Michael Martinovsky, Daly City, CA (US)

(21) Appl. No.: 14/698,599

(22) Filed: Apr. 28, 2015

Related U.S. Application Data
(60) Provisional application No. 61/985,918, filed on Apr. 29, 2014.

(51) Int. Cl. G06F 3/0482; G06F 3/0484; G06F 17/30; G06F 3/0488

(52) U.S. Cl. CPC G06F 3/0482; G06F 3/04886; G06F 3/0484; G06F 17/30312

(57) ABSTRACT

A method and system for time planning and scheduling capable of displaying the scheduled time events on a spiral-shaped timeline in a manner in which all events in a single 18-hour or a single 24-hour period are displayed on one screen in three dimensions and are visible without the use of scrolling and without the user having to access multiple screens.

### CROSS-REFERENCE

This application claims priority from U.S. Provisional Patent Application No. 61/985,918, entitled “Timespiral Calendar,” filed Apr. 29, 2014, and fully incorporated by reference herein.

### FIELD OF THE INVENTION

The invention generally relates to electronic calendaring programs.

### BACKGROUND OF THE INVENTION

Electronic calendars continue to increase in popularity over paper calendars. However, most traditional electronic calendaring programs display scheduled time events in a grid pattern or in a table format, which makes it difficult for users of mobile devices or other devices with small screens to view the scheduled time events of a typical working day without the need for the user to scroll through multiple screens or to zoom in and out of a portion of a screen, or to visually identify the start and end time of an event without looking at the particular numerical time designations on the table or grid.

There exists a need for an electronic calendaring program optimized for a variety of devices, including mobile devices, which is able to display the scheduled time events of a typical working day on a relatively small screen without the need for scrolling through multiple screens.

### SUMMARY OF THE INVENTION

In the following detailed description, reference is made to the accompanying drawings, which form a part of the description and in which are shown, by way of illustration, specific example embodiments. The example embodiments are in such detail as to clearly communicate the invention. However, the amount of detail offered is not intended to limit the anticipated variation of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art. The present invention can be implemented in accordance with numerous aspects consistent with the materials presented herein.

The present invention is directed to electronic data in the form of an electronic calendar. In particular, the present invention is directed to a method and system for time planning and scheduling, which capable of displaying the scheduled time events on a spiral-shaped timeline in a manner in which all events in a time period are displayed on one screen in three dimensions, and where the entire event is visible without the use of scrolling and without the user having to access and view multiple screens. The time period can be 18 hours, 24 hours, or any length preferred by the user. The beginning, end, and duration of each time event are readily visually identifiable and are easily modifiable. By placing the time events on a spiral where the start of the event segment corresponds to a position which would reflect that start time on an analog clock, the user is instantly visually cued into the start, the duration, and the end times of events even in the absence of numeric identification of hours and minutes associated with the start and end times of events.

The graphic interface and input methods of the method and system according to the present invention are optimized for use on mobile touch screen devices. Due to the general limited screen size of mobile devices, the traditional method of displaying calendar information in a grid pattern or in a table format presents certain limitations. Specifically, all events displayed on a grid typically do not fit on a single screen view of a mobile device, which requires a user to scroll or zoom in order to see all scheduled time events. Moreover, typically only a part of the timeline for a particular period is displayed on the screen which makes it difficult for a user to visually identify where on a timeline a certain event is located. This invention is intended to address the inherent limitations of displaying timeline events in a grid pattern or in a table format in two dimensions by plotting time events on a spiral timeline displayed in three dimensions on a single screen view of a mobile device. The screen view of a calendar according to the present invention may contain either a static or dynamic background comprised of a single image or element or a combination of images or elements. These backgrounds are designed to complement the main graphic elements of the screen being displayed.

The system and method of a calendar according to the present invention records and displays events as time intervals positioned on a time line. The time line is a spiral-shaped unbroken line which circles a central point and which does not intersect itself. The progression of hours in any given 18-hour or 24-hour period may be directed towards the central point or away from it. Beginning and end of displayed time events on a timeline are located at the intersection of the timeline and an imaginary line between the central point and the timeline. This imaginary line is drawn in the plane of the calendar at an angle corresponding to the angle of an hour hand of a clock on an imaginary 12 hour clock face, the center point of the timeline corresponding to the center of said imaginary 12 hour clock face. Thus, the method according to the invention allows for depiction of calendar events in an imaginary 12 hours analog clock format in a way where the beginning, ending, and duration of events are readily identifiable. The system is designed to integrate and sync with third party calendaring software which provide API access and a licensing structure which allows for the interface. Alternatively, metadata for this system may be contained in a proprietary database.

### BRIEF DESCRIPTION OF THE DRAWINGS

FIG. 1 is a screen display of a calendar according to an embodiment of the present invention.

FIG. 2 illustrates a screen display of a calendar according to an embodiment of the present invention.

FIG. 3 is a screen display of a calendar according to an embodiment of the present invention.

FIG. 4 illustrates creation and editing of time events according to an embodiment of the present invention.

FIG. 5 illustrates creation of time events according to an embodiment of the present invention.

FIG. 6 is a screen display of a calendar according to an embodiment of the present invention illustrating displaying overlapping events.

FIG. 6a is a screen display of a calendar according to an embodiment of the present invention illustrating displaying overlapping events. FIG. 6b is a screen display of a calendar according to an embodiment of the present invention illustrating tilting the axis of the calendar display for ease of viewing of the overlapping events.

FIG. 7 illustrates the process of a selecting a color for a time event according to an embodiment of the present invention.

FIG. 8 illustrates the process of a selecting a color for a time event according to an embodiment of the present invention.

FIG. 9 illustrates a screen display of a calendar showing the year, month, and dates on one screen according to an embodiment of the present invention.

FIG. 10 is a screen display of a calendar according to an embodiment of the present invention.

FIG. 11 illustrates a block diagram of an electronic calendar according to an embodiment of the present invention.

FIG. 12 illustrates a flowchart for creating of time events in an electronic calendar according to an embodiment of the present invention.

FIG. 13 illustrates a flowchart for editing time events in an electronic calendar according to an embodiment of the present invention.

FIG. 14 illustrates a flowchart for removing time events in an electronic calendar according to an embodiment of the present invention.

FIG. 15 illustrates the process of changing the beginning, end, and/or duration of a time event with a single gesture.

### DETAILED DESCRIPTION OF THE INVENTION

The implementations described herein may be embodied in various types of hardware, software, firmware, and combinations thereof. For example, some techniques disclosed herein may be implemented, at least in part, by computer-readable media that include program instructions, state information, etc., for performing the various services and operations described. Examples of program instructions include machine code, such as produced by a compiler, and files containing higher-level code that may be executed by a computing device such as a server or other data processing apparatus using an interpreter. Examples of computer-readable media include, but are not limited to, magnetic media such as hard disks, floppy disks, and magnetic tape; optical media such as CD-ROM disks; magneto-optical media; and hardware devices that are specially configured to store program instructions, such as read-only memory (“ROM”) devices, random access memory (“RAM”) devices and Flash memory devices.

According to the embodiments of the present invention described herein, a user may create a time event by a drawing gesture with his or her finger a segment on the timeline displayed on a touch screen of a mobile device. The touch and movement of the user's finger on the touch screen may be detected and interpreted by the software and hardware of the mobile device according to methods known in the art, to create a thick band or a colored band on the timeline corresponding to the duration of the time. Control elements to confirm the creation of the event and/or to cancel the creation of the event are also displayed on the screen of the device. When drawing a time event on the timeline, a user selects the start and end time positions on the timeline corresponding to the hour positions on a traditional 12 hour analog clock. When a user draws a time event, a dialog box containing the event details such as event beginning and end times, event title, event notes, alarms, repeat rules and other event-related information may be displayed. The values for the beginning time of the event and the ending time of the event are automatically populated by the time values corresponding to the time demarcation values selected by the user.

When an event is created or edited using a finger swipe gesture on the timeline, time markers corresponding to time designations on a standard 12 hour analog clock face are displayed at the beginning and the end point of the event segment. The purpose of the time markers is to inform the user of the start and end time of the event and to allow the user to precisely calibrate the time parameters of the event prior to confirming the creation of the event. The same time markers are displayed if the start time or the end time of the event is edited through the graphic user interface by manipulating the active zones at the beginning and the end of the time event segment on the timeline.

Both the month view and the week view graphic interfaces are composed of a series of rectangles aligned in a grid, with each of the rectangles displaying information for a particular day of the month or week. In other embodiments, the shape of the figures displaying information for a particular day of the month or week may be circles, ovals or other appropriate geometric shapes. When the user initiates a change of month or change of view, an animation is launched showing the rectangles flipping and illustrating the change of the month or week. After each card completes the rotation around its own axis, it displays either the next day or the preceding day of the month or of the week depending on the position of the card in the grid. The algorithm of accomplishing the animation may be set to flip the cards simultaneously, sequentially, by row, by column, or in any other way.

When a user initiates a creation of a new scheduled time event on the timeline, any previous changes made to the graphic interface by the user, such as changing the viewing angle of the time spiral or zooming in and out, are automatically cancelled and the graphic user interface returns to default values. A date change which is displayed on the main screen, initiated by the user, also results in the cancellation of any previous changes made to the graphic interface by the user and a return to default values.

When an event is created or edited using a finger swipe gesture on the timeline, time markers corresponding to time designations on a standard 12 hour clock face are displayed at the beginning and the end point of the event segment. The purpose of the time markers is to inform the user of the start and end time of the event allowing the user to precisely calibrate the time parameters prior to creating the event. The same time markers are displayed if the start time or the end time of the event is edited through the graphic user interface by manipulating the active zones at the periphery of the event segment on the timeline.

When creating or editing an event on the timeline using a finger swipe gesture, a color palette with a choice of pre set-colors is displayed on the screen near the location of the drawn time event, allowing the user to choose one color out of the palette. The selected color is assigned to the event and populates the event details dialog box called our when the user confirms the event creation or edits the event. In addition, the color selection is applied to the event directly in the database.

To accomplish a quick cancellation of the changes made by the user to the graphic interface, and to return the calendar to the default graphic interface, the user may use an appropriate finger swipe gesture applied to a graphic user interface control cluster displayed on the screen. The active zone of the control element receives a graphic marker at the time when the editable graphic interface parameters are edited in any way which differs from the default state. After the parameters return to default values the graphic marker becomes invisible.

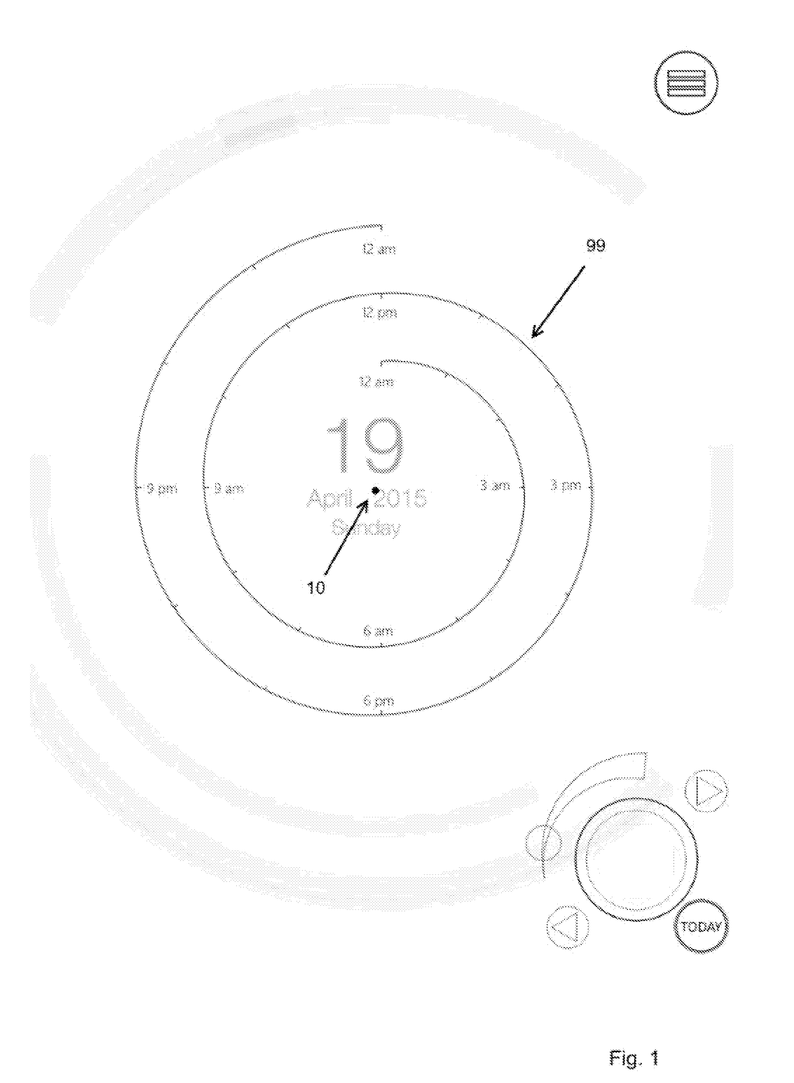

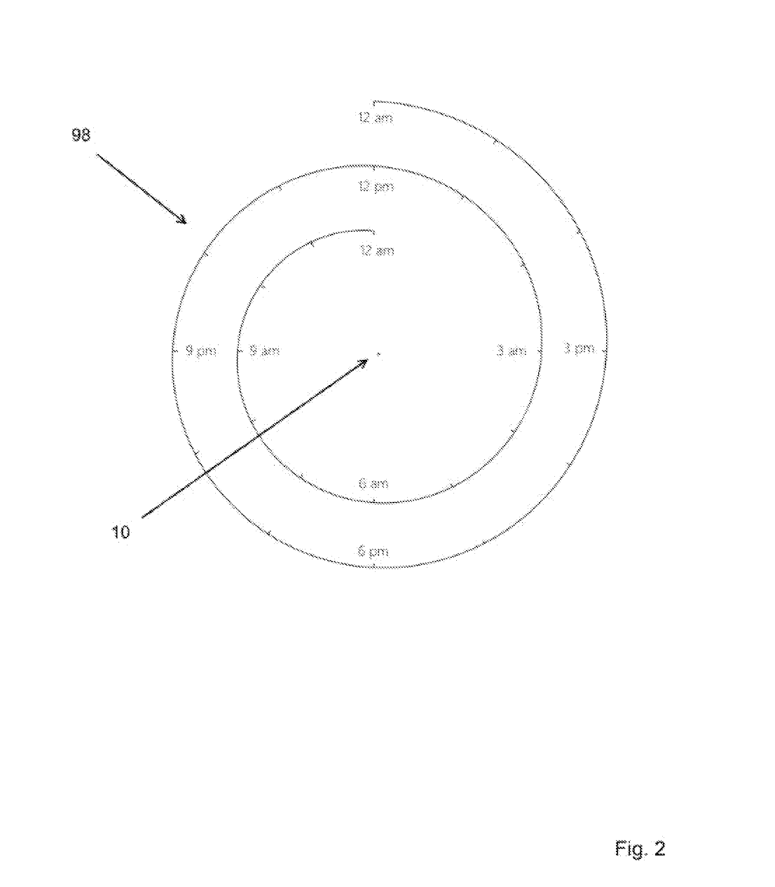

FIGS. 1 and 2 illustrate screen displays of a timeline with time markers of an electronic calendar according to an embodiment of the present invention. The positions of the time markers, such as 6 am, 9 am, 12 pm, 3 pm, 6 pm, 9 pm, and 12 am, generally corresponded to the positions of the corresponding hours on a conventional 12-hour clock face and are thus easily identifiable to a user.

Timeline 99 (as illustrated in FIG. 1), and timeline 98 (as illustrated in FIG. 2), are displayed as a plane curve generated by a point moving around a fixed central point 10 while constantly receding from or approaching said central point 10. The progression of time markers from early in the day (i.e., 6 am) to late in the day (i.e., 12 pm) may be directed towards central point 10 (as illustrated by timeline 98 in FIG. 2) or away from it (as illustrated by timeline 99 in FIG. 1). According to an embodiment of the invention, timelines 98 and 99 may be spiral shaped, square shaped, or hexagonal shaped.

Timelines 98 and 99 may have variable length and/or time duration. According to an embodiment of the invention illustrated in FIGS. 1 and 2, duration of a timeline displayed on the screen may be 24 hours. Using a timeline corresponding to 24 hours allows for displaying all events in a nychthemeron. According to another embodiment of the invention, duration of a timeline may be 18 hours corresponding to a period of time from 6 am to 12 pm. This embodiment displays events during waking hours of the day and may be preferable to using a nychthemeron for certain applications.

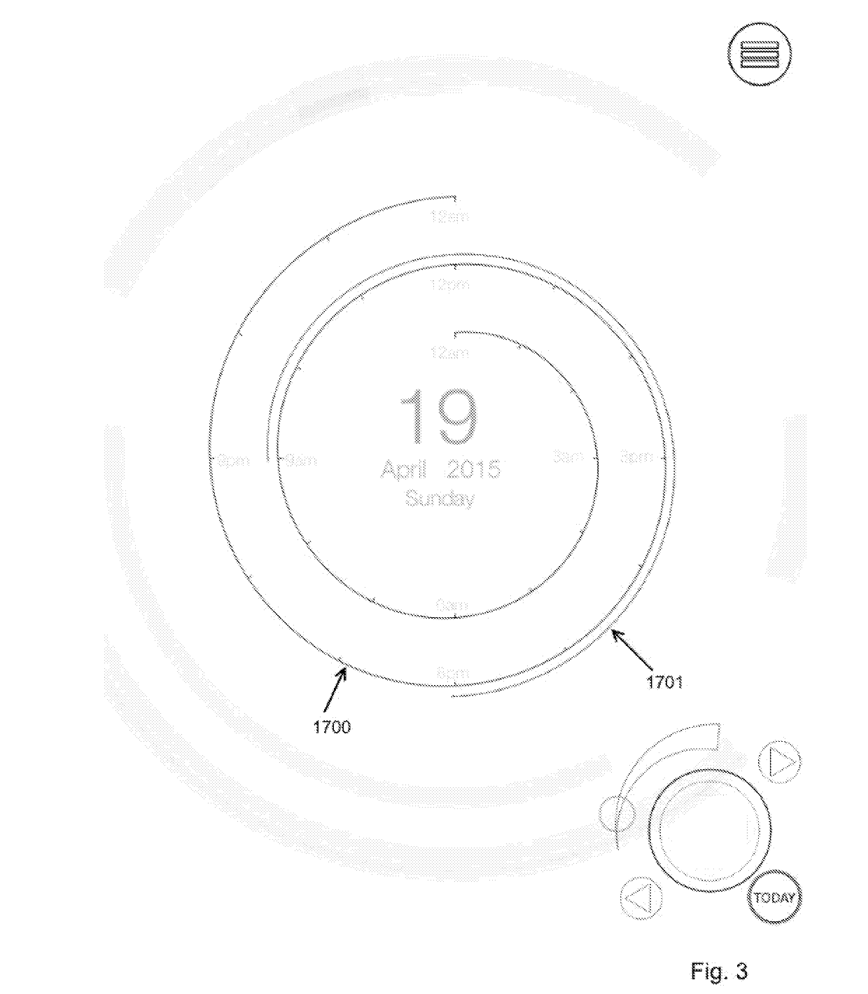

According to an embodiment of the invention illustrated in FIG. 3, a color band 1701 corresponding to the time period of waking time or typical working hours is added to the timeline 1700 in order for the user to easily visually identify typical working hours and/or waking hours. This color band is created for reference only and does not contain any time event data. In an embodiment, the color band may contain a color gradient allowing for a visual orientation of the direction of time. An example of one alternative embodiment may have the color band with a light pink color positioned on the point on the timeline corresponding to the morning and a gradient of colors darkening towards dark blue on the point on the timeline corresponding to the evening.

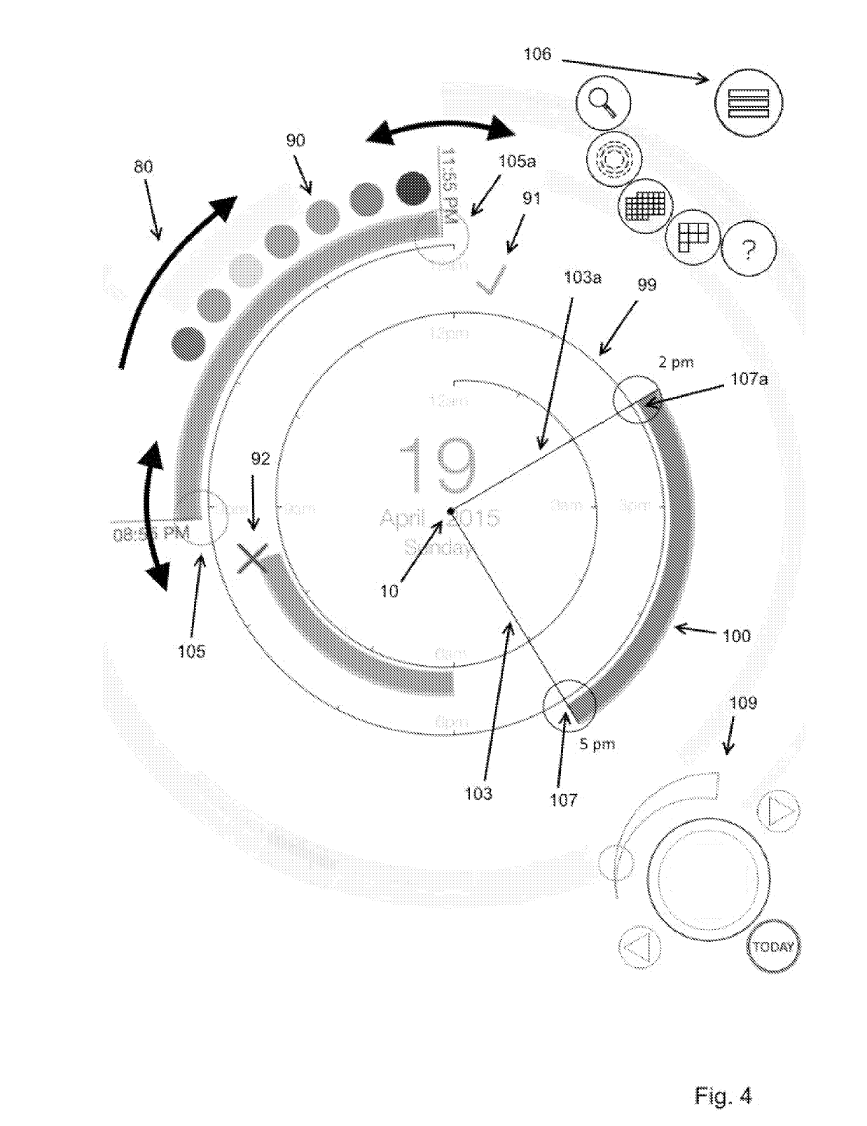

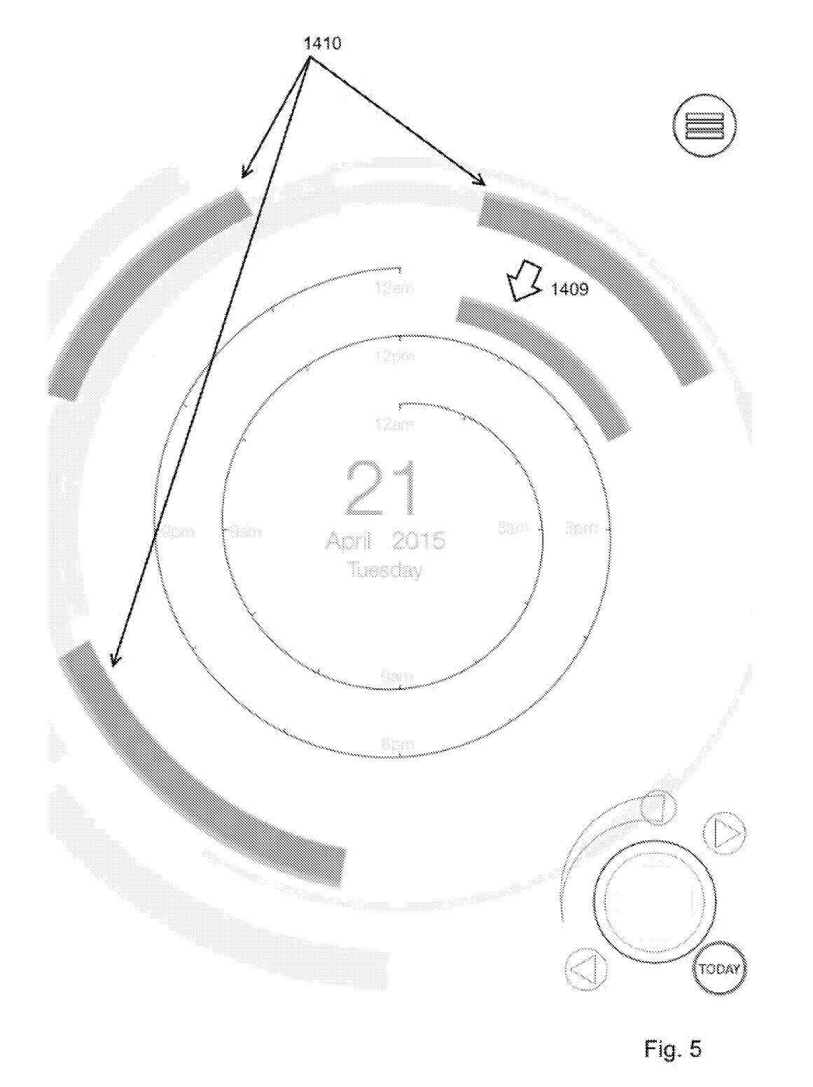

According to an embodiment of the invention illustrated in FIG. 4, a user may create a time event by using a swiping finger gesture 80 on the screen of the calendar display imitating a drawing of the event on a timeline. According to another embodiment of the present invention, a user may create a time event by dragging one of a plurality of predetermined geometric shapes 1410 onto the timeline, as illustrated in FIG. 5. The user may use a gesture 1409 to drag one of the preexisting geometric shapes 1410 from a peripheral portion of the screen and move it onto the timeline at the coordinates corresponding to the desired time of the event. Preexisting geometric shapes 1410 representing the event are programmed with certain pre set parameters such as the length of the event and the user calendar designation where this event will be stored, according to methods known in the art.

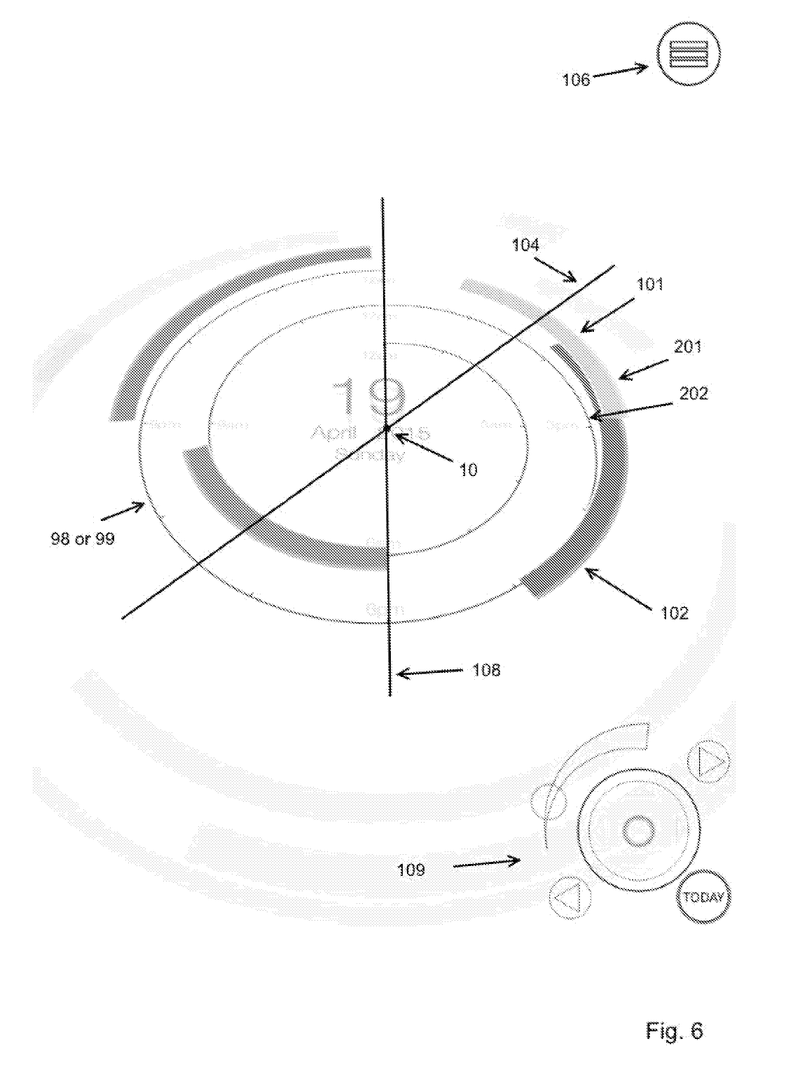

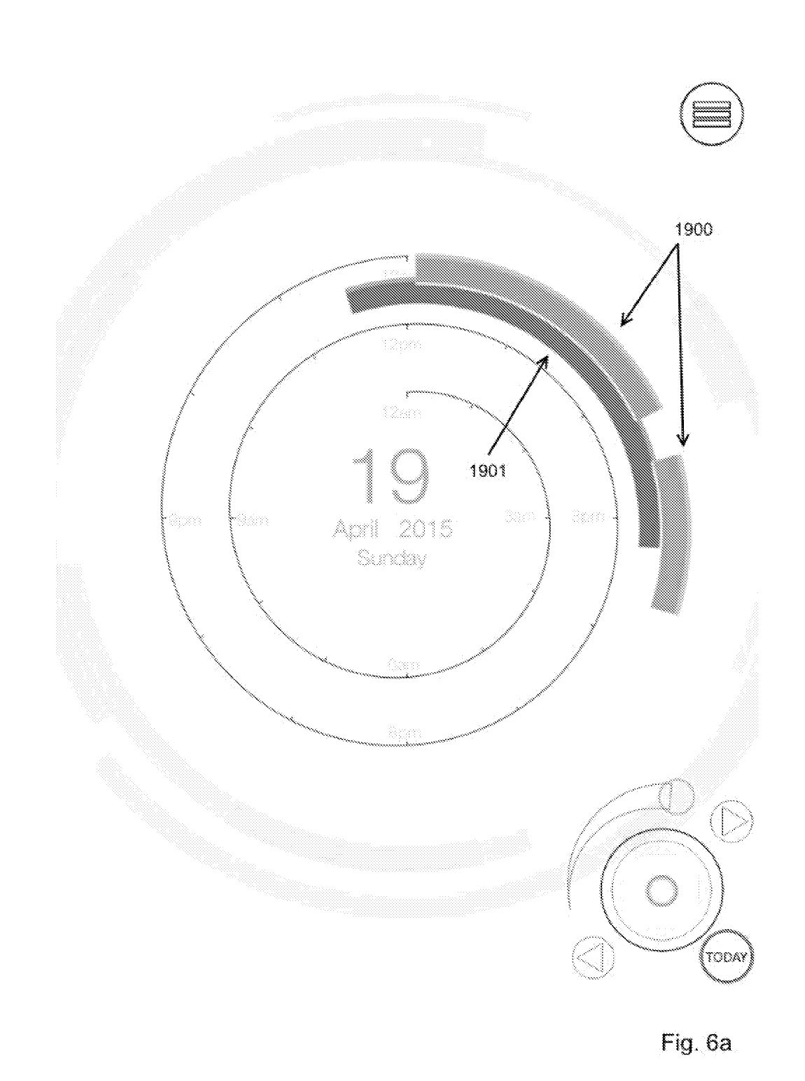

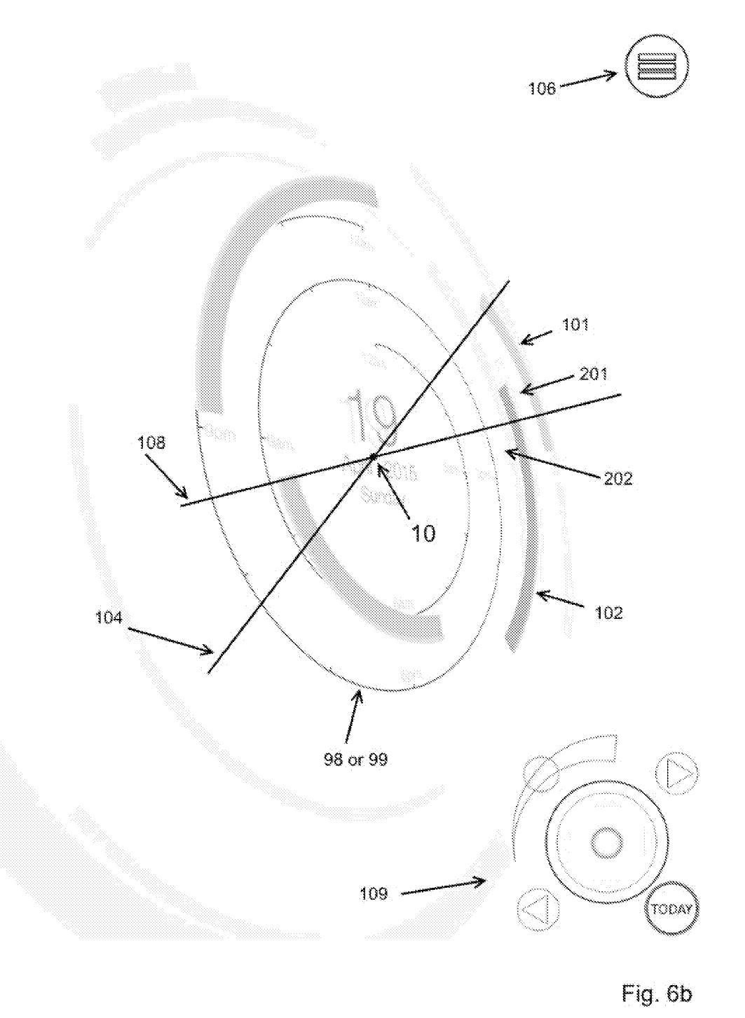

FIGS. 4 and 6 illustrate creation and display of scheduled time events on a timeline of a calendar according to an embodiment of the present invention. As illustrated in FIG. 4, when creating or editing an event on the timeline using a finger swipe gesture 80, a color palette 90 with a choice of pre set-colors is displayed on the screen near the location of the drawn time event, allowing the user to choose one color out of the palette. The selected color is assigned to the event and populates the event details dialog box called our when the user confirms the event creation or edits the event. In addition, the color selection is applied to the event directly in the database. As illustrated in FIG. 4, control element 91 to confirm the creation of the event and control element 92 to cancel the creation of the event are also displayed on the screen of the device.

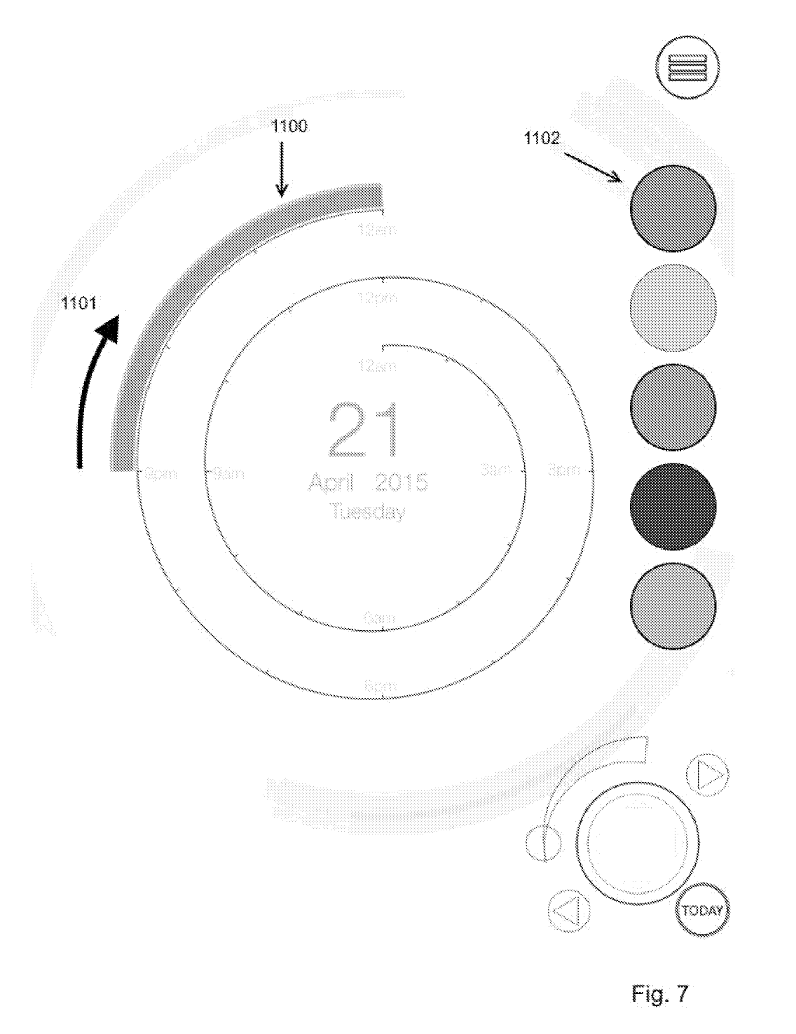

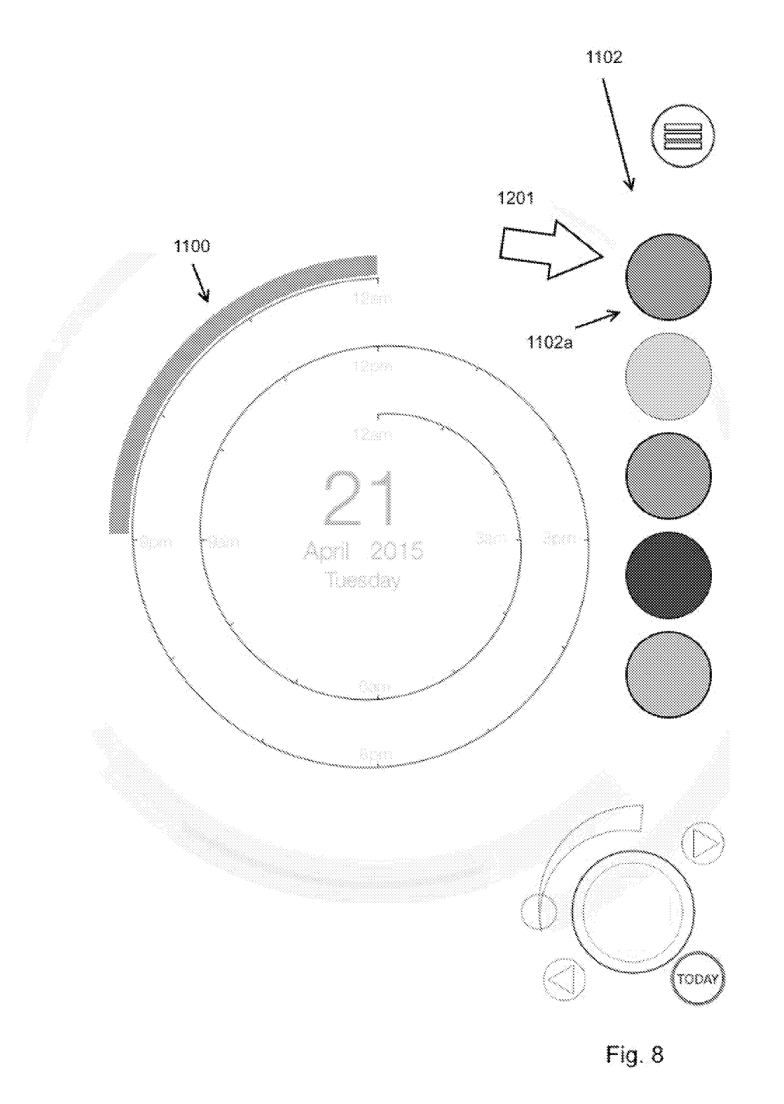

As illustrated in FIGS. 7 and 8, the user is able to choose a calendar color designation for time events corresponding to color designations in a third party calendar database, or, alternatively, corresponding to internal calendar databases. After creating a time event 1100 by using a finger swiping gesture 1101 (FIG. 7), the user would apply touch 1201 to one of the color marker 1102 corresponding to the user's preferred calendar color, and the system will apply the color of the selected marker 1102a to time event 1100. (FIG. 8).

The application allows a user to import events and data from various third party databases, such as Google Calendar or Outlook, by methods known in the art including API import procedures. Color designations of individual events and maintenance of the color code information in the calendar system according to the present invention is separate and distinct from the source values color designations of said third party databases. Since some of the third party databases allow the user to designate a color code for a particular event, this application will allow the user to designate a different color code to each event by choosing from the color palette 90 as described when the event is created or edited independent from the original color code designated by the source third party database. The application will maintain the color codes assigned to each event in its own native format and database.

As illustrated in FIG. 4, a clearly visually designated graphic user interface control clusters 106 and 109 are displayed on the screen. According to an embodiment of the invention, by using elements of the control cluster 106, the user can search for events, change the display to date selection mode, month display mode, or week display mode, or launch tutorials. According to an embodiment of the invention, a user can change the beginning and ending time of the time event with the length of the time event remaining unchanged. As shown in FIG. 4, scheduled time event 100 is located between time markers 107 and 107a. Time segment 100 is displayed as a thicker segment of timeline 99. In alternative embodiments, the scheduled time event 100 may displayed as a segment of a color which is different from the color of timeline 99, for easy visualization of the event.

In an embodiment of the invention illustrated in FIG. 4, graphic interface control cluster 109 is visually displayed as a joystick type control with a central button. Control cluster 109 includes multi-purpose controls that allow the user to change the distance between the planes containing scheduled events, to move to a future or past date, to return to the current date, and to change the angle of the tilt of the plane containing the timeline and the graphic representations of the events thereon, relative to the plane of the screen.

As illustrated in FIG. 4, active control zone time markers 107 and 107a are located at the intersection of timeline 99 and imaginary lines 103 and 103a, respectively, drawn from the central point 10 towards timeline 99. Time markers 107 and 107a represent the beginning and the end of time event 100. The angles of lines 103 and 103a correspond to the angles of an hour hand on an imaginary 12-hour clock face. The center point 10 corresponds to the center of such imaginary 12-hour clock face.

Event 100 is displayed in the customary 12 hour clock position on timeline 99 in FIG. 4 as a thick line or a stripe that may be darkened or colored based on the user preferences. The beginning, end, and duration of event 100 are thus easily visually identifiable, as is illustrated in FIG. 4 where point 107a corresponds to 2 pm and point 107 corresponds to 5 pm. All the scheduled events are displayed on one screen without the need for scrolling regardless of screen size.

As illustrated in FIG. 4, when creating or editing a time event by using a finger swipe gesture 80, clearly visually designated active control zone markers 105 and 105a appear on the screen display. Active control zone markers 105 and 105a allow the user to change the beginning and ending time of the event, and to precisely calibrate the time parameters of an event by dragging the active control zones 105 and 105a to the desired points on the timeline. A precise calibration of the duration of an event and a more precise setting of the start time and/or the end time of an event (i.e. 8:55 am to 11:55 am), is accomplished by a finger swipe gesture which moves markers 105 and 105a along the timeline 99.

If the active control zone time maker corresponding to the beginning of the event is moved in the direction of the active control zone time marker corresponding to the end of the event, then when the two markers are overlapping on the timeline, continued user input moving the beginning active control zone maker in the same direction will move the two markers together. Moving the beginning active control zone maker in the opposite direction after having moved the two markers simultaneously will result in the ending active control zone maker remaining stationary. The same simultaneous movement can be achieved by moving the ending active zone control marker in the direction of the beginning active control zone maker. This process allows the user to change the time and length of the event in one motion and without taking the finger off the screen.

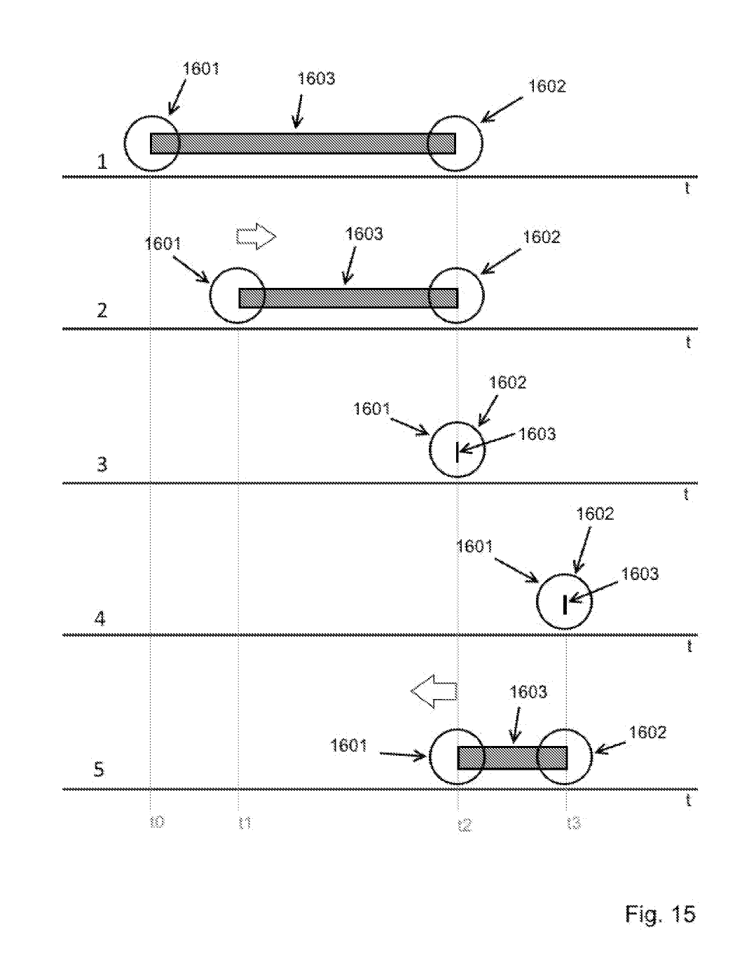

As illustrated in FIG. 15, moving active control zone time maker 1601 from position t0 to position t1 towards active control zone time maker 1602 will decrease the length of a time event 1603 on the timeline. (FIG. 15, time lines 1 and 2). If the user moves the active control zone time maker 1601 so that it converges with active control zone time maker 1602 at position t2, the length of event 1603 becomes null, however, all of the event data (event name, location, color, etc.) will be saved with the event start time and the event end time having the same value of t2. (FIG. 15 line 3.) If the user continues to move the active control zone time maker 1601 in the same direction, past the active control zone time maker 1602 on the timeline, the merged active control zone time makers 1601 and 1602 will move together on the timeline, effectively moving the beginning and the end time of event 1603 on the timeline to t3. (FIG. 15, line 4). When the user has reached the desired end of the time event at t3, the user may move the active control zone time maker 1601 in the opposite direction on the timeline until the user reaches the desired start of the time event at t2. (FIG. 15, line 5). All the user-selected data for time event 1603, such as event name, event location, color associated with the time event, and any other identifying data regarding the event entered by the user will be preserved through the entire process described in this paragraph. Only the beginning, the end, and the duration of the time event will receive new values according to user input.

Events which overlap in time such as, for example, overlapping time events 101 and 102, as illustrated in FIG. 6, may be stacked one of top of another in a three dimensional screen display in order to clearly identify such overlapping events. Time segments having the shorter length (or duration) may be placed above time segments having a longer duration, or vice versa. The purpose of this arrangement is to ensure that the shorter time event 101 is not obscured from the user's view by the longer time event 102. In FIGS. 6 and 6b, overlapping time events 101 and 102 occupy parallel overlapping planes on the calendar display and are shown as separated from each other by distance 201, and are also shown as separated from timeline 99 by distance 202. Distances 201 and 202 may be changed by the user using finger swipe controls, or through the use of the multipurpose control element 109, for ease of visualization and to allow a user to easily visualize multiple overlapping events. FIG. 6a illustrates a display of overlapping time events 1900 and 1901 according to an embodiment of the present invention.

As illustrated in FIG. 6, coordinate axis 104 lies parallel to the plane of the calendar display. The overlapping time events 101 and 102 share a common coordinate axis 108 which is perpendicular to the plane of the calendar display and intersects the plane of the calendar display at central point 10. The angle of the axis 108 can be changed through controls provided in the graphic interface cluster 109. As illustrated in FIG. 6b, while the angle of axis 108 may change, axis 108 remains at all times perpendicular to the plane of the calendar display upon which events are displayed, which creates the visual effect of viewing the entire timeline spiral and the events displayed thereon sideways or at any angle set by the user.

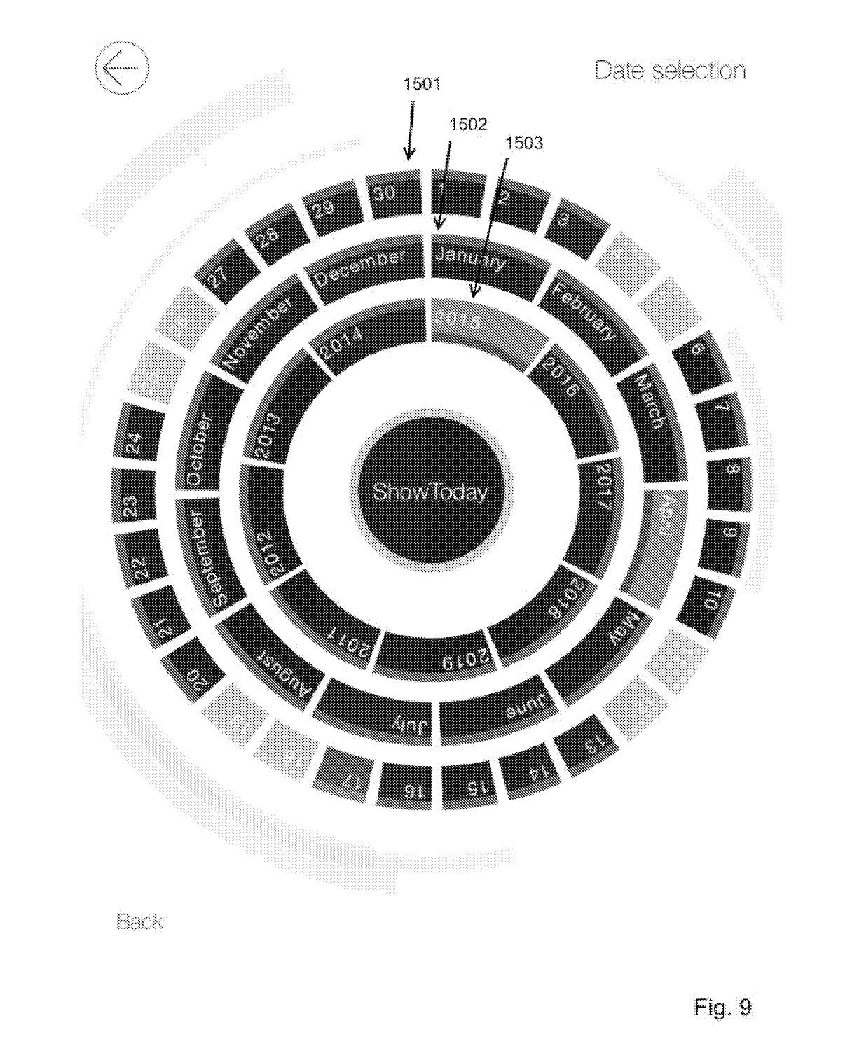

FIG. 9 illustrates a screen display of an electronic calendar according to an embodiment of the invention, showing the years, the months and the dates selected by the user. The screen display includes multifunctional elements 1501, 1502 and 1503, graphically represented as a plurality of concentric circles upon which the years (current year and/or multiple years), the months, and days of the month corresponding to the month which is selected by the user are displayed. The circle representing the days of the month is selected dynamically by the system to display the days of the current month, as illustrated in FIG. 9, or any other particular month which is selected by the user.

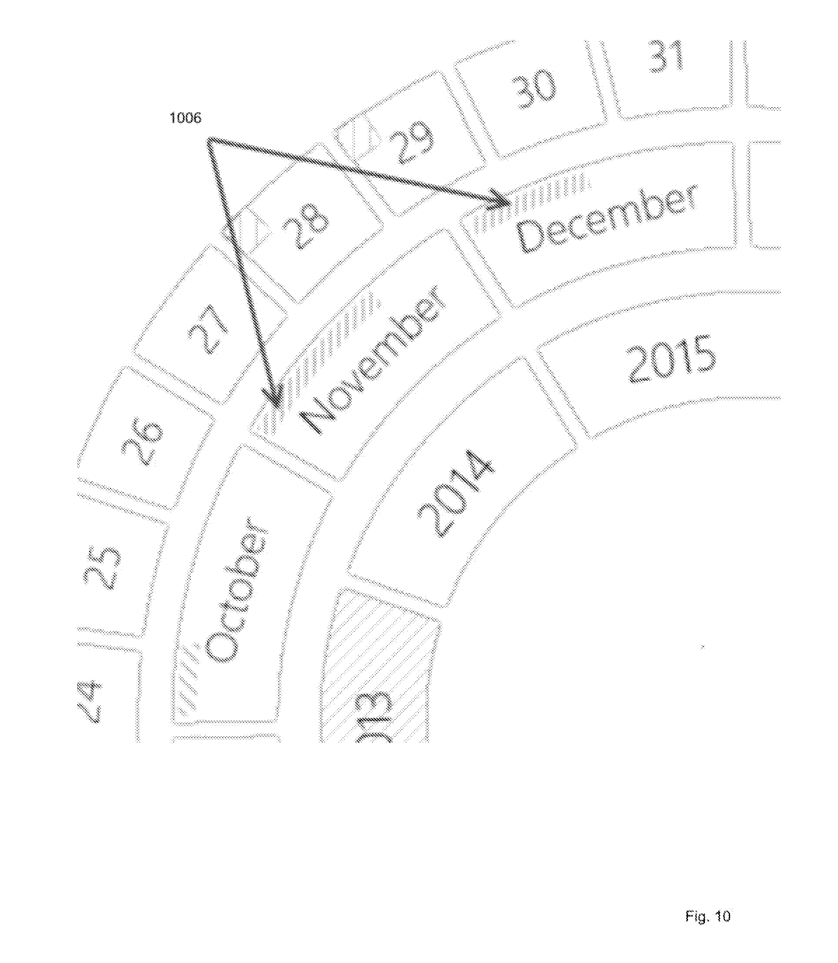

As illustrated in FIG. 10, a graphic indicator 1006 which visually indicates presence of scheduled time events may be added to the calendar display. Graphic indicator 1006 may also visually display the ratio of scheduled time events (busy time) in comparison to the remaining available time (free time).

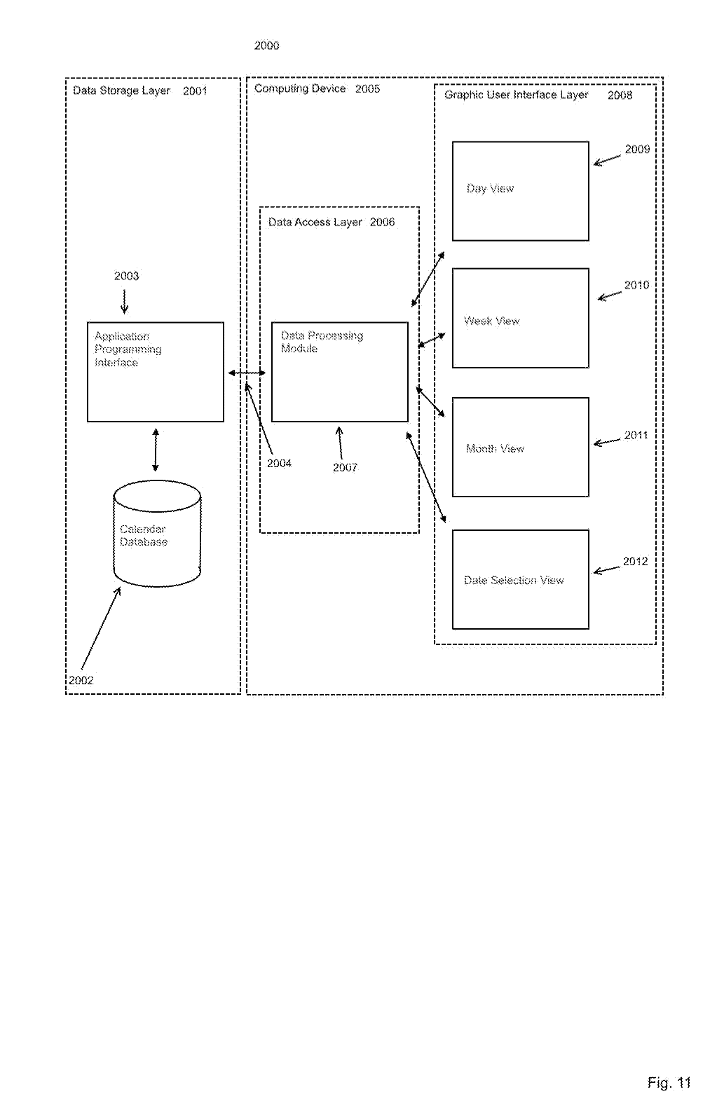

FIG. 11 illustrates an exemplary electronic calendar system 2000 having a data storage layer 2001 comprising a calendar database 2002 to store calendar entries and an application programming interface 2003 for accessing calendar database 2002. Calendar database 2001 can comprise any type or form of database now known or developed in the future, including a proprietary format database or a commercially available third party database such as Outlook or Google Calendar, which provides API access and a licensing structure which allows for the interface, and can include any type of item having events which are properly associated with a calendar.

Data storage layer 2001 communicates with a computing device 2005 via electronic communications means 2004. Electronic communications means 2004 include wired or wireless networks local area networks and wide area networks. While the calendar database 2002 is illustrated as a standalone item, it could be included within one of the computing devices 2005 or a different dedicated database computing device. Computing device 2005 can comprise any type of calculating device, such as smart phones, portable digital assistants (PDAs), personal computers, cell phones, wristwatches, and any other type of device that has the ability to perform calculations and display a calendar.

Computing device 2005 has a dedicated data access layer 2006 comprising a data processing module 2007. Each data processing module 2007 operates within an associated computing device 2005, and is in communication with the calendar database 2002. In other embodiments, a centralized data processor could be utilized in addition to or in place of the individual dedicated data processing module 2007.

Data processing module 2007 generates calendar displays on graphic user interface layer 2008. Graphic user interface layer 2008 comprises day view 2009, week view 2010, month view 2011, and date selection view 2012 as illustrated in FIGS. 1-10. The actual calendar entries are stored in the calendar database 2002.

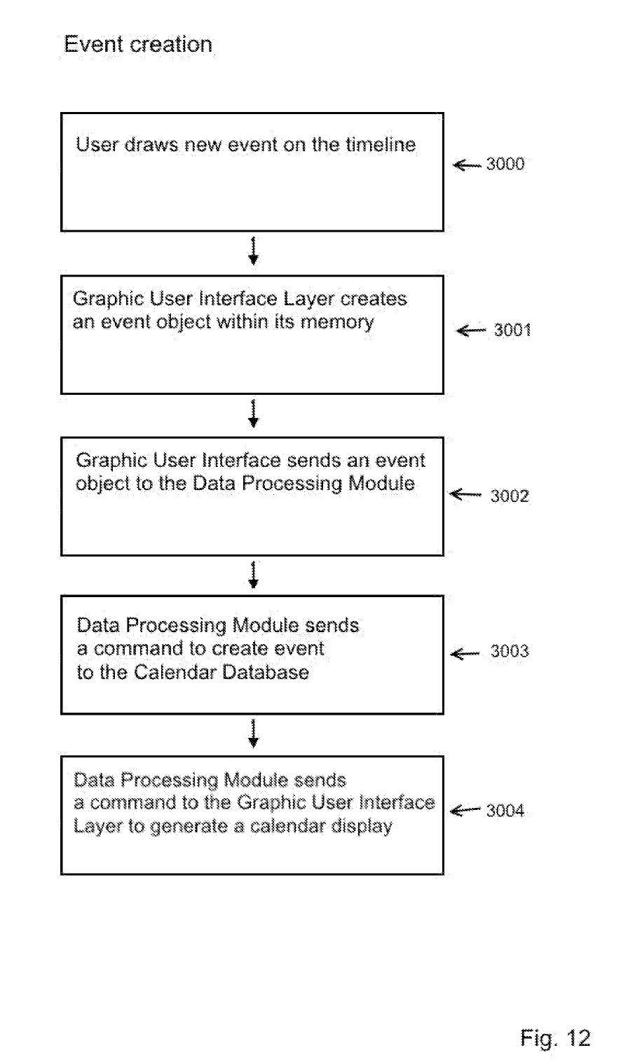

FIG. 12 illustrates an exemplary method for generating a time event. In item 3000, the use created a new event as described and illustrated in FIG. 4. In item 3001, the graphic user interface layer 2008 creates an event object corresponding to a scheduled time event in its memory. In item 3002, the graphic user interface layer 2008 sends the event object to the data processing module 2007. In item 3003, the data processing module 2007 sends a command to create a scheduled time event to the calendar database 2002. In item 3004, the data processing module 2007 sends a command to the graphic user interface layer 2008 to generate a calendar display of the scheduled time event.

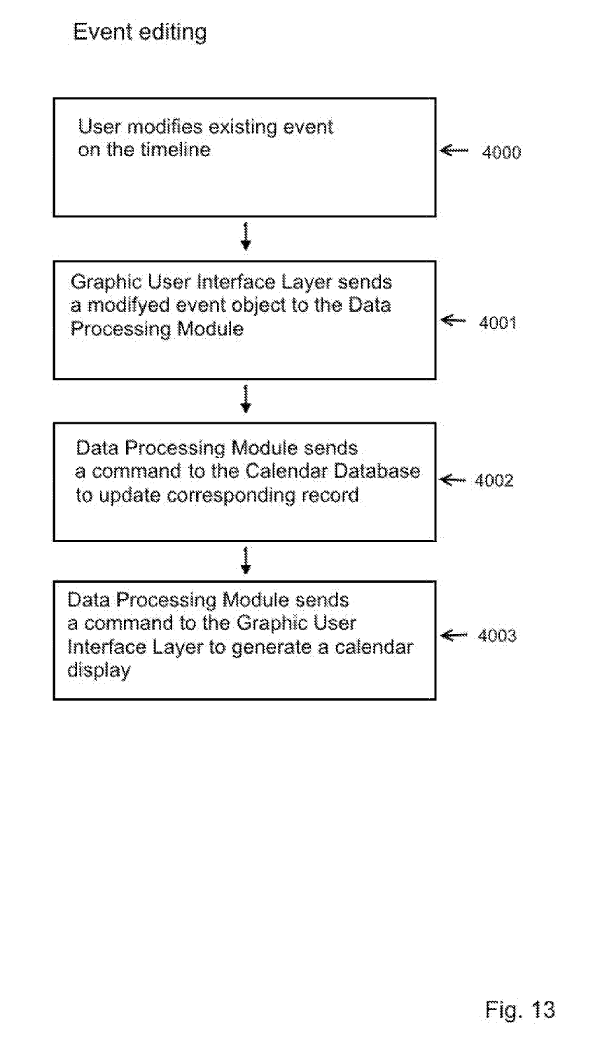

FIG. 13 illustrates an exemplary method for editing a time event. In item 4000, a user modifies a previously scheduled time event as described and illustrated in FIG. 4. In item 4001, the graphic user interface layer 2008 sends a modified event object to the data processing module 2007. In item 4002, the data processing module 2007 sends a command to modify the corresponding scheduled time event to the calendar database 2002. In item 4003, the data processing module 2007 sends a command to the graphic user interface layer 2008 to generate a modified calendar display modifying the event.

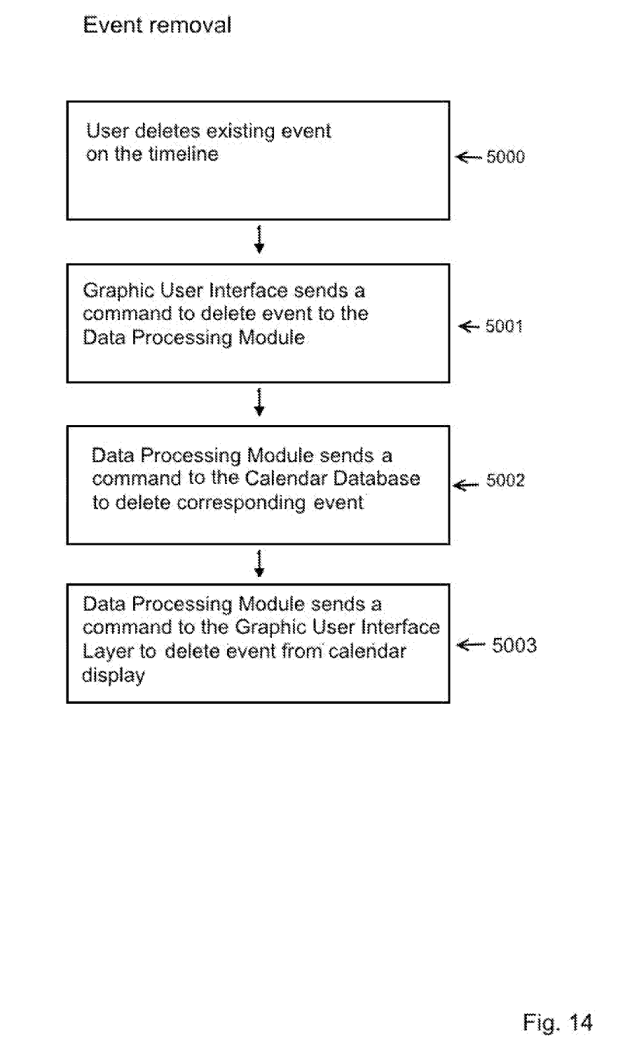

FIG. 14 illustrates an exemplary method for removing a time event from the calendar display. In item 5000, a user deletes a previously scheduled time event as described and illustrated in FIG. 4. In item 5001, the graphic user interface layer 2008 sends a command to delete event to the data processing module 2007. In item 5002, the data processing module 2007 sends a command to delete the corresponding scheduled time event to the calendar database 2002. In item 5003, the data processing module 2007 sends a command to the graphic user interface layer 2008 to generate a modified calendar display deleting the event.

It will be apparent to those skilled in the art having the benefit of this disclosure that the inventions shown and described in the detailed description and the figures are to be taken merely as examples. Although the present invention and some of its advantages have been described in detail for some embodiments, it should be understood that various changes, substitutions and alterations can be made herein without departing from the spirit and scope of the invention as defined by the appended claims. Further, embodiments may achieve multiple objectives but not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention.

1. A method for displaying calendar events, the method comprising
storing data for calendar entries in a database;
generating according to user input a calendar display of a timeline on a graphic user interface of an electronic device using a data processor, wherein said timeline is displayed as a spiral on a single screen of said device.

2. A method according to claim 1 wherein said timeline comprises a plurality of time events.

3. A method according to claim 1 wherein time markers are positioned on said timeline in locations corresponding to hour positions on a 12-hour analog clock face.

4. A method according to claim 1 wherein said timeline is displayed at an angle set by a user

5. A method according to claim 1 wherein said timeline comprises a 24-hour period.

6. A method according to claim 1 wherein said timeline comprises an 18-hour period.

7. A method according to claim 2 wherein said plurality of time events is displayed in three dimensions.

8. A method according to claim 2 wherein said plurality of time events is displayed in color.

9. A method according to claim 2 wherein overlapping time events are displayed as stacked one on top the other.

10. A method according to claim 9 wherein time events of shorter duration are displayed as stacked one on top of time events of longer duration.

11. A method according to claim 9 wherein time events with a later start time are displayed as stacked one on top of time events with an earlier start time.

12. A method according to claim 1 wherein said user input comprises a finger swipe across the touch screen of said electronic device.

13. A method according to claim 1 wherein said user input comprises moving predetermined geometric shape onto said timeline.

14. A method according to claim 2 wherein graphic markers are displayed at the beginning and at the end of each of said plurality of time events.

15. A method according to claim 1 wherein said timeline graphically identifies the period of working hours of a day.

16. A method for displaying calendar events, the method comprising
storing data for calendar entries in a database;
generating according to user input a calendar display of a time events on a graphic user interface of a device using a data processor, wherein said time events are displayed as a plurality of concentric circles on a single screen of said device.

17. A method according to claim 16 wherein said calendar display indicates the busy percentage of a time period.

18. A system for generating an electronic calendar comprising
an electronic device;
one or more stored sequences of instructions which, when executed by said electronic device, cause the electronic device to carry out the steps of:
storing data for calendar entries in a database;
generating according to user input a calendar display of a timeline on a graphic user interface of an electronic device using a data processor; wherein said timeline is displayed as a spiral on a single screen of said device.

19. A system for generating an electronic calendar comprising
an electronic device;
one or more stored sequences of instructions which, when executed by said electronic device, cause the electronic device to carry out the steps of:
storing data for calendar entries in a database;
generating according to user input a calendar display of a time events on a graphic user interface of a device using a data processor, wherein said time events are displayed as a plurality of concentric circles on a single screen of said device.

20. A non-transitory computer-readable storage medium encoded with executable instructions for generating an electronic calendar in an electronic device, which, when executed by a processor cause the process or carry out the steps of:
storing data for calendar entries in a database;
generating according to user input a calendar display of a timeline on a graphic user interface of an electronic device using a data processor; wherein said timeline is displayed as a spiral on a single screen of said device.

21. A non-transitory computer-readable storage medium encoded with executable instructions for generating an electronic calendar in an electronic device, which, when executed by a processor cause the process or carry out the steps of:
storing data for calendar entries in a database;
generating according to user input a calendar display of a time events on a graphic user interface of a device using a data processor, wherein said time events are displayed as a plurality of concentric circles on a single screen of said device.
